(19) United States
(12) Patent Application Publication
(10) Pub. No.: US 2007/0039385 A1
(43) Pub. Date: Feb. 22, 2007

(54) Resistive thin film humidity sensitive device based on silicone-containing copolymer and its preparation method

(76) Inventors: Mujie Yang, Hangzhou (CN); Dehuan Huang, Mountain View, CA (US)

Correspondence Address: ROSENBERG, KLEIN & LEE, 3458 ELLICOTT CENTER DRIVE-SUITE 101, ELLICOTT CITY, MD, 21043, US

(21) Appl. No.: 11/206,051

(22) Filed: Aug. 18, 2005

(51) Int. Cl. G01N 27/12

(52) U.S. Cl. 73/335.05

(57) ABSTRACT

Disclosed is a resistive thin film humidity sensitive device based on silicone-containing copolymer and its preparation method. The device includes a microlite glass substrate; a plurality of interdigital gold electrode pairs, which are evaporated and photolithographically defined onto the microlite glass substrate; lead lines connecting to the interdigital gold electrodes; and a humidity sensitive film coated onto the microlite glass substrate and surface of the interdigital gold electrodes, and the humidity sensitive film is a cationic polyelectrolyte-silicone containing copolymer. The method for preparing the device includes the steps of: (1) dipping a microlite glass substrate having interdigital gold electrodes in a solution containing humidity sensitive materials by a Dip-Coater, and obtaining a humidity film after lifting and heat treatment; and (2) aging the interdigital gold electrodes coated with humidity sensitive film on microlite glass substrate at a specific electric condition, humidity and temperature condition, and obtaining the resistive-type thin film humidity sensitive device based on silicone-containing copolymer. Advantages of the present invention include broad humidity detection range, high sensitivity, fast response speed, simple process for production, low cost, and is widely applicable to detection and control of a process and environmental humidity.

### BACKGROUND OF THE INVENTION

1. Field of the Invention

The present invention relates to a resistive thin film humidity sensitive device based on silicone-containing copolymer and its preparation method.

2. The Prior Arts

Society advancement and technology development create a broad area for sensor usage. Humidity sensor is one of the important chemical sensors. It is widely used in the fields of warehousing, industrial production, procedure control, environmental monitoring, home electronic appliance, and weather science. It plays an important role in the modem technology development and our daily life. Currently, polymeric humidity sensor is a novel humidity sensor used widely, which generally includes two types, capacitive-type and resistive-type. The resistive-type humidity sensor has many advantages, including good response property, broad humidity detection range, simple process for production, easy combination with other device, manufacturing in small scale and in batch, and low price, and therefore becomes a trend of research and development. The commonly used humidity sensitive material is polyelectrolyte. The polyelectrolyte is advantageous for low price, simple process for production, high sensitivity, and fast response to humidity adsorption. However, it also has the disadvantages including slow desorption response, difficulty in detection in low humidity environment, poor resistance at high humidity, low response sensitivity under high humidity environment, and poor stability and reliability for long term operation. The disadvantages limit practical application and further development of humidity sensor based on the polyelectrolyte, and result from that the polyelectrolyte is a material easy to adsorb water molecule but difficult to detach. Also, adhesion between the humidity sensitive film and substrate is not so well and it may cause the film to swell and desorb easily.

### SUMMARY OF THE INVENTION

The object of the present invention is to provide a resistive thin film humidity sensitive device based on silicone-containing copolymer and its preparation method.

The resistive-type thin film humidity sensitive device based on silicone-containing copolymer in accordance with the present invention comprises a microlite glass substrate; a plurality of interdigital gold electrode pairs, which are evaporated and photolithographically defined onto the microlite glass substrate; lead lines connecting to the interdigital gold electrodes; and a humidity sensitive film coated onto the microlite glass substrate and surface of the interdigital gold electrodes, and the humidity sensitive film is a cationic polyelectrolyte-silicone containing copolymer.

A method for preparing the resistive thin film humidity sensitive device based on silicone containing copolymer is disclosed, which comprises the steps of:

(1) Dipping a microlite glass substrate having interdigital gold electrodes in the solution containing humidity sensitive materials for 1-4 minutes by a Dip-coater with a lifting speed of 2-8 mm/sec, and then heating at 80-120° C. for 5-15 hours to obtain a humidity sensitive thin film; and

(2) Aging the interdigital gold electrodes coated with humidity sensitive film on microlite glass substrate at a AC voltage of 100-800 mV, 1 kHz and 30-40° C for 20-50 hours under a humidity environment of 60-90% RH to obtain the resistive thin film humidity device based on silicone-containing copolymer.

Advantages of the present invention include:

(1) Application of a specifically designed interdigital gold electrode: There are 8-16 pairs in an interdigital gold electrode, wherein the interdigital width and interdigital space is 20-80 μm and 40-80 μm, respectively. Each interdigital length is 2-3 mm, the electrode size is 6 mm×5 mm×0.5 mm. It has the advantages including small volume, low cost, and convenient usage. The electrode structure is so thin and dense that it can reduce impedance, increase sensitivity, and thereby to detect humidity under a low humidity environment and broaden the humidity detection range.

(2) Polymerization of polymerizable cation monomer ([2-(methacryloyloxy)ethyl]dimethyl butyl ammonium bromide) and functional siloxane monomer (γ-methacryloxypropyl trimethoxy silane) is achievable to prepare a humidity sensitive film by controlling the composition of the silicone-containing copolymer. Adequate mol ratio of the two monomers and concentration of the solution containing humidity sensitive materials make the humidity sensitive device have a particularly fast response to humidity adsorption and desorption.

(3) Introducing of functional siloxane monomer into the silicon copolymer allows the siloxyl group (Si—OR) in siloxane hydrolase converse into silanol group (Si—OH), wherein the latter can form a hydrogen bonding with the hydroxyl group on microlite glass substrate. Thus, adhesion between the humidity sensitive film and the microlite glass substrate is enhanced and the humidity resistance of humidity sensitive under high humidity environment is increased.

(4) The disadvantage of fast humidity adsorption but slow desorption in the conventional resistive-type polymeric humidity sensitive device is overcome by introducing the functional siloxane monomer into the silicone-containing copolymer. Adjusting the ratio of siloxane monomer in copolymer can adjust the desorption speed of the humidity sensitive device because the siloxane group is hydrophobic.

(5) Aging the device at a specific AC voltage and 30-40° C. under a humidity environment of 60-90% RH allows the device to reach a stable state in a shorter period, and provides the device with high stability and ability of humidity resistance to high humidity environment.

(6) The present invention provides a humidity sensitive device, which combines a polymeric humidity sensitive material polymerized by polymerizable cation monomer and functional siloxane monomer with a specific designed interdigital gold electrode on microlite glass substrate, and constructs an advanced polymeric resistive-type humidity sensitive device with both advantages and excellent humidity sensitive properties. The device has the advantages of broad humidity detection range (5-100% RH), high sensitivity, high resistance to high humidity environment, good humidity sensitive properties even in a low humidity range, fast response speed, small hysteresis, simple process for production, good uniformity, low cost, and applicability to produce in batch.

### BRIEF DESCRIPTION OF THE DRAWINGS

FIG. 1 Scheme of the configuration of the humidity sensitive device according to the present invention;

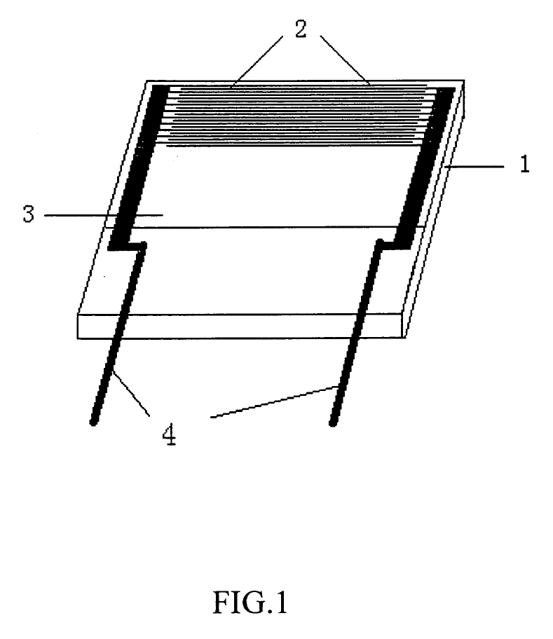

FIG. 2 Typical humidity response curve of the humidity sensitive device according to the present invention;

FIG. 3 Typical hysteresis curve of the humidity sensitive device according to the present invention; and

FIG. 4 Typical response time curve of the humidity sensitive device according to the present invention.

### DETAILED DESCRIPTION OF THE PREFERRED EMBODIMENT

The present invention combines a polymeric humidity sensitive material polymerized by polymerizable cation monomer and functional siloxane monomer with a specific designed interdigital gold electrode on microlite glass substrate, and constructs a polymeric resistive-type humidity sensitive device with advantages. Quaternary ammonium salt in the copolymer provides movable ions, and the hydrophobic siloxane can be used to adjust the speed of desorption. Moreover, the siloxyl group in the solution containing humidity sensitive materials converts into a silanol group, and forms a hydrogen bonding with the hydroxyl group on microlite glass substrate, thereby enhancing adhesion between the humidity sensitive film and the microlite glass substrate. Also, the thin and dense interdigital gold electrode on microlite glass substrate can reduce the impedance of humidity sensitive device to increase the sensitivity. Thus, the polymeric resistive-type humidity sensitive device with excellent properties can be obtained, and the process for production of the device is simple and low cost.

The resistive-type thin film humidity sensitive device based on silicone-containing copolymer comprises a microlite glass substrate 1; a plurality of interdigital gold electrodes 2, which is evaporated and photolithographically defined onto the microlite glass substrate; lead lines 4 connecting to the interdigital gold electrodes; and a humidity sensitive film coated onto the microlite glass substrate and surface of the interdigital gold electrodes, and the humidity sensitive film 3 is a cationic polyelectrolyte-silicone containing copolymer.

Eight (8) to sixteen (16) pairs of interdigital gold electrodes are evaporated and photolithographically defined onto the microlite glass substrate. The interdigital width and interdigital space of interdigital gold electrodes is 20-80 μm and 40-80 μm, respectively. Each interdigital length is 2-3 mm, and the electrode size is 6 mm×5 mm×0.5 mm. Humidity sensitive film is a cationic polyelectrolyte-silicone containing copolymer. It is copolymerized by polymerizable cation monomer ([2-(methacryloyloxy)ethyl]dimethyl butyl ammonium bromide) and functional siloxane monomer (γ-methacryloxypropyl trimethoxy silane) in a mol ratio of 1-6:1. The solution containing humidity sensitive materials is consisted of 1-6 parts by weight of silicone-containing copolymer and 100 parts by weight of deionized water.

### EXAMPLE 1

(1) Cleaning of electrode: The microlite glass substrate having interdigital gold electrodes is dipped in absolute alcohol and acetone for cleaning, respectively, and dried by heating to use for the next step.

(2) Deposition of humidity sensitive film by dip-coating and after treatment: The microlite glass substrate having interdigital gold electrodes is dipped in the solution containing humidity sensitive materials (the solution contains 20 parts by weight of silicone-containing copolymer and 100 parts by weight of deionized water, and the mol ratio of quaternary ammonium salt to siloxane in silicone-containing copolymer is 4:1) for 4 minutes, then lifted at a speed of 8 mm/sec. Finally, the treated microlite glass substrate is put into a constant temperature oven and heated at 80° C. for 15 hours to obtain the humidity sensitive thin film.

(3) Aging treatment: The humidity sensitive device with humidity sensitive film on the microlite glass substrate having interdigital gold electrodes is put into a constant temperature and humidity chamber, and aged at a AC voltage of 800 mV, 1 kHz and 40° C. for 20 hours in a humidity environment of 60% RH.

### EXAMPLE 2

(1) Cleaning of electrode: The cleaning procedure is the same as Example 1.

(2) Deposition of humidity sensitive film by dip-coating and after treatment: The microlite glass substrate having interdigital gold electrodes is dipped in the solution containing humidity sensitive materials (the solution contains 40 parts by weight of silicone-containing copolymer and 100 parts by weight of deionized water, the mol ratio of quaternary ammonium salt to siloxane in silicone-containing copolymer is 2:1) for 2 minutes, then lifted at a speed of 6 mm/sec. Finally, the treated microlite glass substrate is put into a constant temperature oven and heated at 110° C. for 8 hours to obtain the humidity sensitive thin film.

(3) Aging treatment: The humidity sensitive device with humidity sensitive film on the microlite glass substrate having interdigital gold electrodes is put into a constant temperature and humidity chamber, and aged at a AC voltage of 300 mV, 1 kHz and 30° C. for 30 hours in a humidity environment of 90% RH.

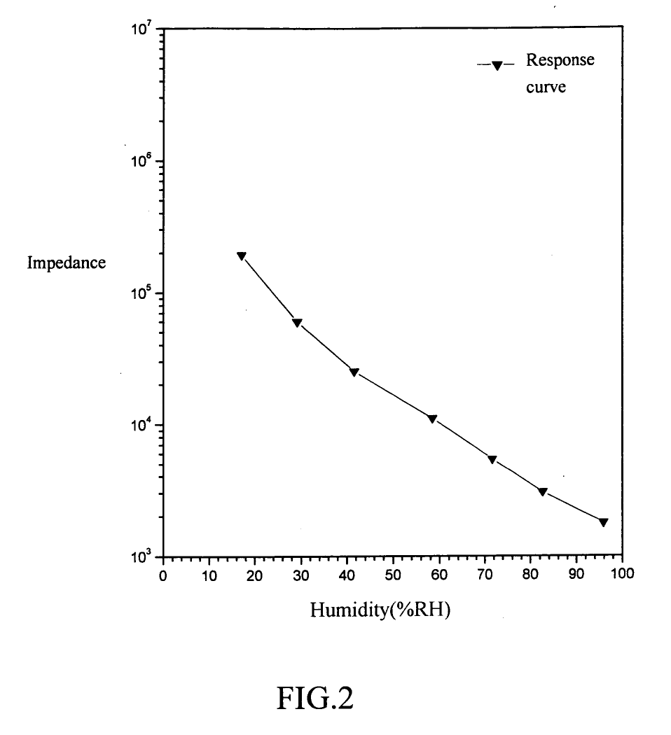

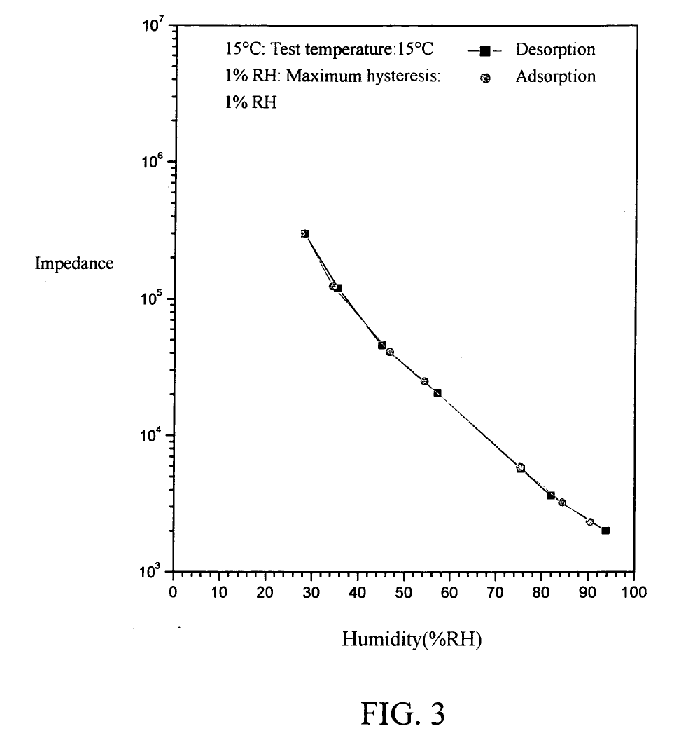

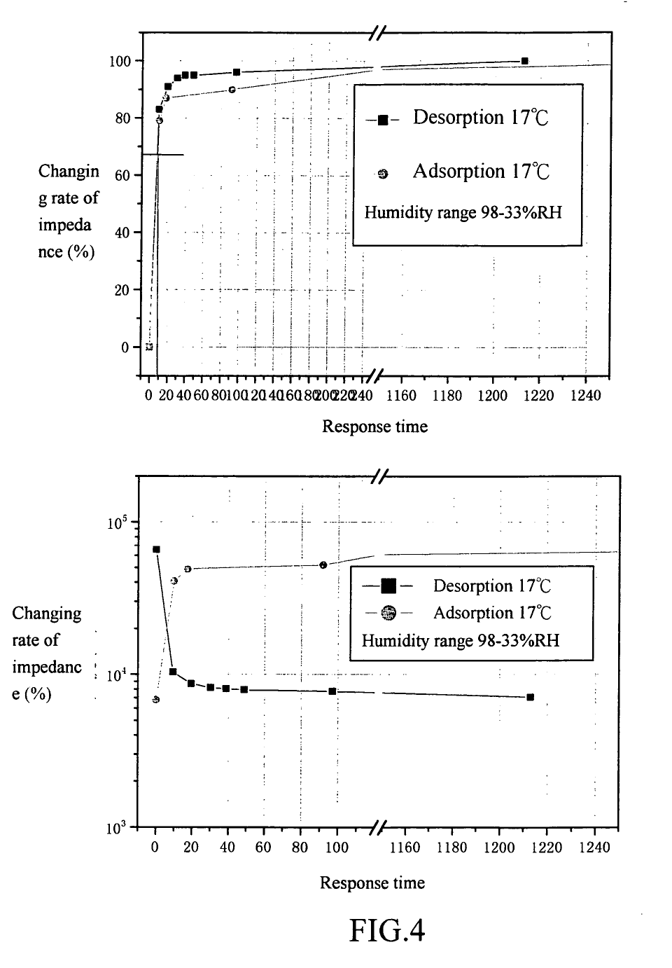

The humidity response curve is shown in FIG. 2, the hysteresis curve is shown in FIG. 3, and the response time curve is shown in FIG. 4.

### EXAMPLE 3

(1) Cleaning of electrode: The cleaning procedure is the same as Example 1.

(2) Deposition of humidity sensitive film by dip-coating and after treatment: The microlite glass substrate having interdigital gold electrodes is dipped in the solution containing humidity sensitive materials (the solution contains 60 parts by weight of silicone-containing copolymer and 100 parts by weight of deionized water, the mol ratio of quaternary ammonium salt to siloxane in silicone-containing copolymer is 6:1) for 1 minutes, then lifted at a speed of 2 mm/sec. Finally, the treated microlite glass substrate is put into a constant temperature oven and heated at 120° C. for 5 hours to obtain the humidity sensitive thin film.

(3) Aging treatment: The humidity sensitive device with humidity sensitive film on the microlite glass substrate having interdigital gold electrodes is put into a constant temperature and humidity chamber, and aged at a AC voltage of 100 mV, 1 kHz and 30° C. for 50 hours in a humidity environment of 80% RH.

### EXAMPLE 4

(1) Cleaning of electrode: The cleaning procedure is the same as Example 1.

(2) Deposition of humidity sensitive film by dip-coating and after treatment: The microlite glass substrate having interdigital gold electrodes is dipped in the solution containing humidity sensitive materials (the solution contains 40 parts by weight of silicone-containing copolymer and 100 parts by weight of deionized water, the mol ratio of quaternary ammonium salt to siloxane in silicone-containing copolymer is 1:1) for 3 minutes, then lifted at a speed of 4 mm/sec. Finally, the treated microlite glass substrate is put into a constant temperature oven and heated at 90° C. for 12 hours to obtain the humidity sensitive thin film.

(3) Aging treatment: The humidity sensitive device with humidity sensitive film on the microlite glass substrate having interdigital gold electrodes is put into a constant temperature and humidity chamber, and aged at a AC voltage of 600 mV, 1 kHz and 35° C. for 25 hours in a humidity environment of 80% RH.

What is claimed is:

1. A resistive thin film humidity sensitive device based on silicone-containing copolymer, comprising:
a microlite glass substrate;
a plurality of interdigital gold electrode pairs, which are evaporated and photolithographically defined onto the microlite glass substrate;
lead lines connecting to the interdigital gold electrodes; and
a humidity sensitive film coated onto the microlite glass substrate and surface of the interdigital gold electrodes, and the humidity sensitive film is a cationic polyelectrolyte-silicone containing copolymer.

2. The device as claimed in claim 1, wherein the interdigital gold electrodes comprising 8-16 pairs are evaporated and photolithographically defined onto the microlite glass substrate, interdigital width and interdigital space of the interdigital gold electrodes is 20-80 μm and 40-80 μm, respectively, each interdigital length is 2-3 mm, and the electrode size is 6 mm×5 mm×0.5 mm.

3. The device as claimed in claim 1, wherein the humidity sensitive film is a cationic polyelectrolyte-silicone containing copolymer. It is copolymerized by polymerizable cation monomer ([2-(methacryloyloxy)ethyl]dimethyl butyl ammonium bromide) and functional siloxane monomer (γ-methacryloxypropyl trimethoxy silane) in a mol ratio of 1-6:1.

4. A method for preparing the resistive thin film humidity sensitive device based on silicone-containing copolymer, which comprises the steps of:
(1) Dipping a microlite glass substrate having interdigital gold electrodes in a solution containing humidity sensitive materials for 1-4 minutes by a Dip-Coater with a lifting speed of 2-8 mm/sec, and then heating at 80-120° C. for 5-15 hours to obtain a humidity thin film; and
(2) aging the interdigital gold electrodes coated with humidity sensitive film on microlite glass substrate at a AC voltage of 100-800 mV, 1 kHz and 30-40° C. for 20-50 hours under a humidity environment of 60-90% RH to obtain the resistive thin film humidity sensitive device based on silicone-containing copolymer.

5. The method as claimed in claim 4, wherein the interdigital gold electrodes comprising 8-16 pairs are evaporated and photolithographically defined onto the microlite glass substrate, interdigital width and interdigital space of the interdigital gold electrodes is 20-80 μm and 40-80 μm, respectively, each interdigital length is 2-3 mm, and the electrode size is 6 mm×5 mm×0.5 mm.

6. The method as claimed in claim 4, wherein the solution containing humidity sensitive materials is consisted of 1-6 parts by weight of silicone-containing copolymer and 100 parts by weight of deionized water.
